(19) United States
(12) Patent Application Publication
(10) Pub. No.: US 2011/0135795 A1
(43) Pub. Date: Jun. 9, 2011

(54) Tamale maker

(76) Inventor: Leandro J. Lopez, Riverside, CA (US)

(21) Appl. No.: 12/592,912

(22) Filed: Dec. 4, 2009

(51) Int. Cl. A23P 1/08; A21C 9/04

(52) U.S. Cl. 426/274; 99/450.1; 99/450.7

(57) ABSTRACT

A device and method for making Tamales having: a lower surface, an upper surface, connecting means for attaching said upper surface to the lower surface, the lower surface has means for receiving a tamale wrapper, the upper surface has a cut out portion in the middle of the upper surface for applying a masa spread to the tamale wrapper on the lower surface, wherein a user desires to make tamales, the tamale wrapper is positioned such that the front of the tamale wrapped is positioned over the cut out hole in the upper surface, then the upper surface is positioned on the tamale wrapper to prevent the wrapper from moving, then said masa spread is applied to the tamale wrapper through the cut out portion, then a leveling device is used to compact the masa, then the leveling device is used to scrap away any excess masa spread, and wherein the masa spread has been applied to the tamale wrapper, then a tamale filling is placed on a portion of the masa spread, then the tamale wrapper with the masa spread is folded over the tamale filing to trap the filling between the masa spread so that the tamale is now ready for cooking.

### CROSS-REFERENCE TO RELATED APPLICATIONS

This application claims priority under 35 U.S.C. 120 and under applicable U.S. statutes and regulations, to U.S. patent application Ser. No.: 29/314,214, filed Mar. 13, 2009. The disclosure of which is hereby incorporated herein by reference in its entirety.

### FIELD OF THE INVENTION

The present invention generally relates to tools and equipment used in the preparation of food and more particularly this application pertains to a device used in making tamales.

### BACKGROUND OF THE INVENTION

A tamale is a traditional Mexican dish, consisting of steam-cooked corn dough called masa with or without a filling. Tamales can be filled with meats, cheese, and sliced chillis or any preparation according to taste. The tamale is generally wrapped in a corn husk or plantain leaves before cooking, depending on the region from which they come.

Conventionally, tamales are made from corn, also known as maize. One known method of preparing tamale rolls involves mixing corn masa (corn masa is made by soaking and cooking corn in water with lye treatment, and then grinding to a paste), lard, water or broth, and spices into a corn meal tamale dough which is placed on a corn husk wrapped around a filling (such as meat or cheese filling) and steamed to make tamale roll with filling, the tamale.

Instead of preparing corn masa, another conventional method used to prepare tamale rolls involves the use of Masa Harina flour, an alkaline treated corn flour with desirable flavor and dough consistency, which is mixed with lard, salt, baking powder, water or broth and spices to form the tamale dough which is placed on a corn husk wrapped around a filling (such as meat or cheese filling) and steamed to make tamale.

In both cases, it is very difficult to determine how much corn meal dough should be applied to each “wrapper” to hold it (the “wrapper” may be, for instance, corn husks, banana leaves or corn leaves). As such, there is a need in the art for a device that can help user's determine how much masa should be applied to each wrapper to achieve the perfect tamale. This invention seeks to address that problem.

In general, tamales are very soft and fragile. As such, the making of tamales has always been by hand. It is a very labor-intensive process, which can add substantially to the time and costs to prepare it. In addition, as the tamales are created, people will generally grab the tamales, thereby effecting the shape of the tamale.

The present invention addresses the problems associated with the prior art and provides for a device to help users from effecting the shape of the tamale when it is being made. The present invention seeks to provide a device that can assist users in compacting the masa on a tamale wrapper to prevent breaking and cracking.

The present invention seeks to provide a simple and inexpensive device that the average person can use in his own kitchen to prepare tamales by applying the proper amount of masa to each tamale.

Many people who were not raised in the hot tamale making tradition lack the finger dexterity to roll these delicious food items by hand, and the present invention is particularly addressed to help them.

It is not suggested as a device for use in commercial establishments where high speed, high volume production is necessary, but is suggested for those who live a less hectic life style and are willing to take the time to provide the best tasting foods.

### SUMMARY OF THE INVENTION

The present invention specifically addresses and alleviates the above deficiencies associated with the prior art. In this regard, the present invention provides a substantial need in the art for a new tamale making device.

It is the object of the present invention to provide a device that can assist users in holding the tamale wrappers in place while an application of the Masa spread is applied.

It is an object of this invention to accommodate various size tamale wrappers.

It is the object of the present invention to provide a device that can assist users in applying the proper amount of masa to a tamale.

It is the object of the present invention to provide a device that can assist users in compacting the masa on a tamale wrapper to prevent breaking and cracking of the tamale.

It is also an object of this invention to allow novices to proceed with hardest part of preparing a tamale, applying and compacting the masa.

The present invention addresses the problems associated with the prior art and provides for a device to help users from effecting the shape of the tamale when it is being made.

The present invention seeks to provide a simple and inexpensive device that the average person can use in his own kitchen to prepare tamales.

It is an object of this invention to allow the user to prepare the tamale wrapper in a controlled environment to provide a faster and better product.

It is also an object of the present invention to provide a tamale making device that is easy to manufacture, reliable in operation, and relatively inexpensive to produce.

It is also an object of this invention to provide a method of using this device to make a perfect tamale.

### BRIEF DESCRIPTION OF THE DRAWINGS

These as well as other features of the present invention will become more apparent upon reference to the accompanying drawings wherein like numerals designate corresponding parts in the several figures summarized as follows:

FIG. 1 is an exploded perspective view of the Tamale Making Device with a tamale wrapper.

FIG. 2 is a perspective view of the Tamale Making Device having a tamale wrapper positioned between the upper base and the lower base.

FIG. 3 is a view of the Tamale Making Device showing masa applied to the tamale wrapper positioned between the upper base and the lower base.

FIG. 4 is a view of the Tamale Making Device showing masa applied to the tamale wrapper positioned between the upper base and the lower base and a spreader for compacting and spreading the masa.

FIG. 5 is a view of a spreader compacting and spreading the masa, when the masa is applied to the tamale wrapper positioned between the upper base and the lower base of the Tamale Making Device.

FIG. 6 is another view of the Tamale Making Device showing masa applied to the tamale wrapper positioned between the upper base and the lower base and the spreader having compacted and spreaded the masa.

FIG. 7 is an exploded perspective view of the Tamale Making Device showing the upper base being removed and showing the masa compacted and applied to the tamale wrapper.

FIG. 8 is a view of the Tamale Making Device showing that a second application of masa can be applied to the tamale wrapper positioned between the upper base and the lower base.

FIG. 9 is another view of the Tamale Making Device showing that a second application of masa is compacted and spread by the spreader.

FIG. 10 is an exploded perspective view of the Tamale Making Device showing the upper base being removed and showing a second application of the masa compacted and applied to the tamale wrapper.

Other features and advantages of the invention will be become apparent from the following detailed description, taken in conjunction with the accompany drawings, which illustrate, by way of example, various features of the invention.

### DETAILED DESCRIPTION OF THE PREFERRED EMBODIMENTS

The following detailed description and accompanying drawings are provided for purposes of illustrating and describing presently preferred embodiments of the present invention and are not intended to limit the scope of the invention in anyway. It will be understood that various changes in the details, materials, arrangements of parts or operational conditions which have been herein described and illustrated in order to explain the nature of the invention may be made by those skilled in the art within the principles and the scope of the invention.

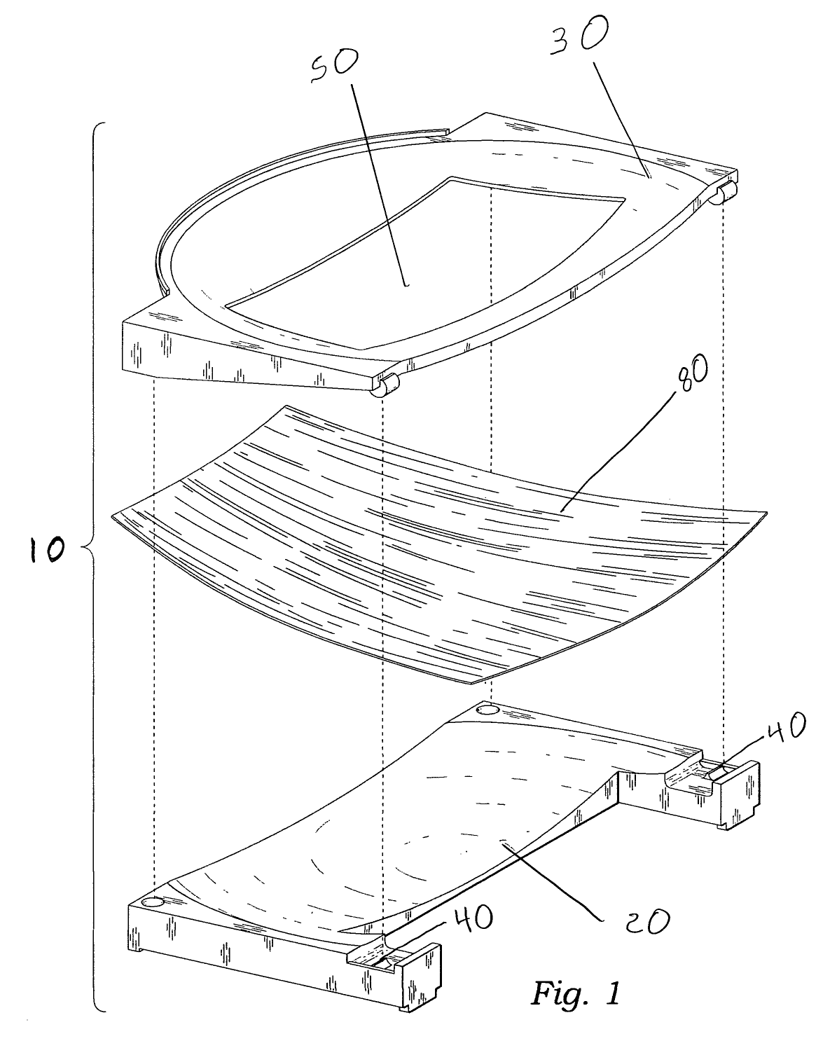

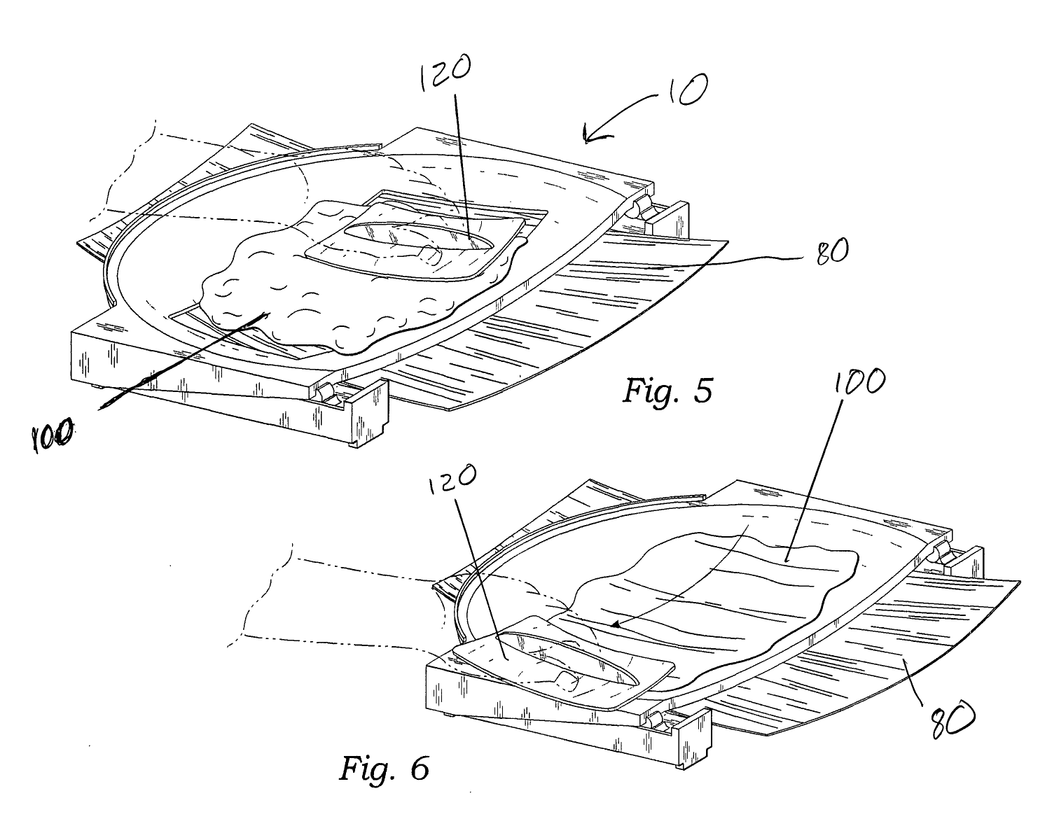

Referring to the drawings more particularly by reference numbers, FIGS. 1 through 10 show a preferred embodiment of the invention, a tamale making device 10 comprising: a lower surface 20, an upper surface 30, connecting means 40 for attaching said upper surface to said lower surface, said lower surface has means for receiving a tamale wrapper 80, and said upper surface 30 has a cut out portion 50 in the middle of said upper surface 30 for applying a masa spread 90 to said tamale wrapper 80 on said lower surface 20.

Wherein a user desires to make tamales, said tamale wrapper 80 is positioned such that the front of the tamale wrapper is positioned over the cut out hole 50 in said upper surface 30, then said upper surface 30 is positioned on the tamale wrapper 80 to prevent said wrapped from moving, then said masa spread 100 is applied to the tamale wrapper 80 through the cut out portion 50, then a leveling device 120 is used to compact the masa 100, then said leveling device 120 is used to scrap away any excess masa 100.

Wherein after said masa spread has been applied to said tamale wrapper, then a tamale filling is placed on a portion of the masa spread, then said tamale wrapper with said masa spread is folded over said tamale filing to trap said filling between said masa spread so that the tamale is ready for cooking.

Wherein said filling can be selected from various meats, cheeses, and sliced chili peppers.

When the masa is folded, it may be wrapped around an edible filling such as meat or cheese or peppers.

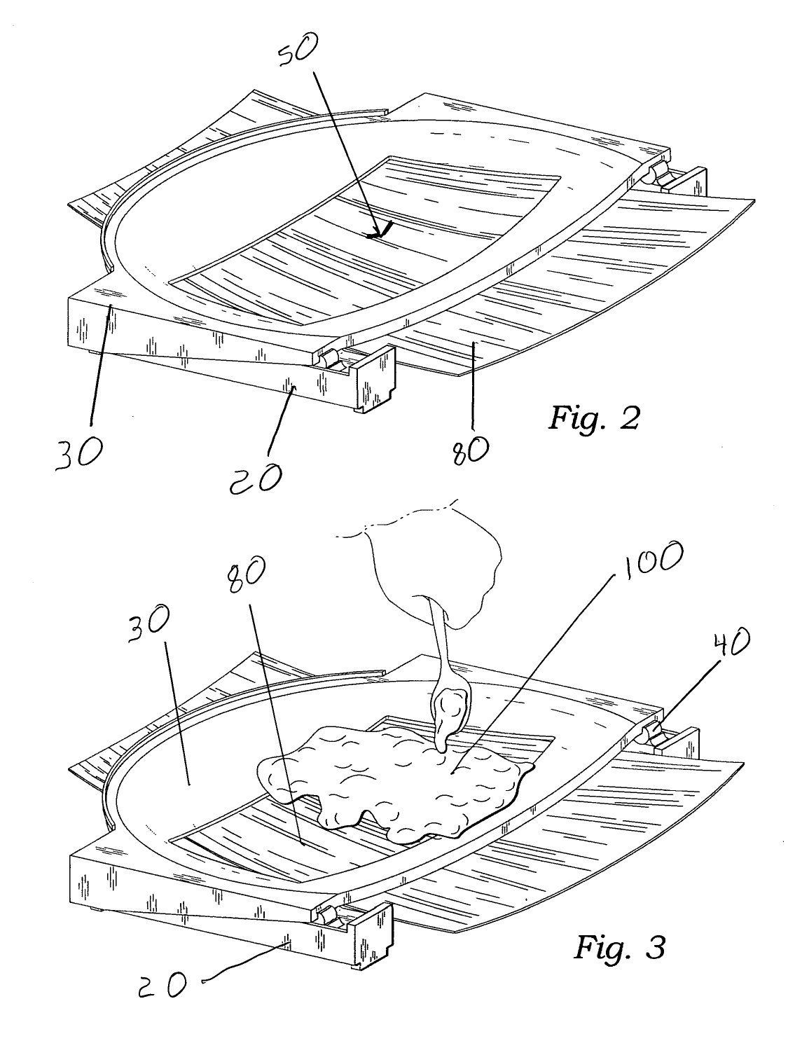

FIGS. 1 and 2 shows is a view of the Tamale Making Device 10 with a tamale wrapper 80 positioned between the upper base 30 and the lower base 20.

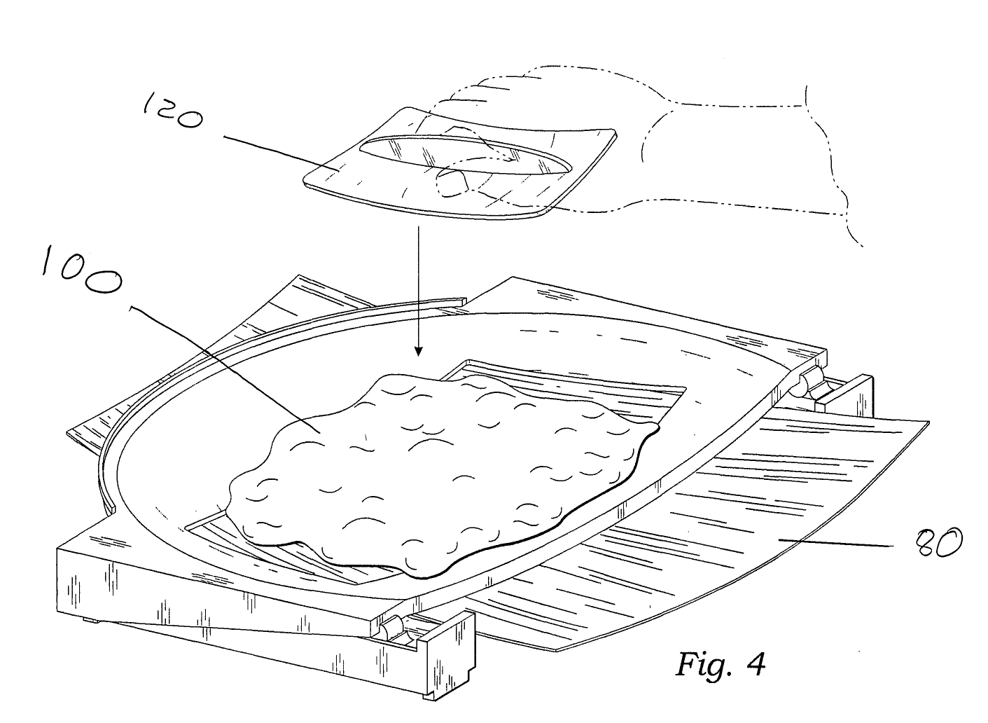

FIG. 3 is a view of the Tamale Making Device 10 showing masa 100 applied to the tamale wrapper 80 positioned between the upper base 30 and the lower base 20. FIGS. 4, 5, and 6 show a view of the Tamale Making Device 10 showing masa 100 applied to the tamale wrapper 80 positioned between the upper base 30 and the lower base 20 and a spreader 120 for compacting and spreading the masa 100.

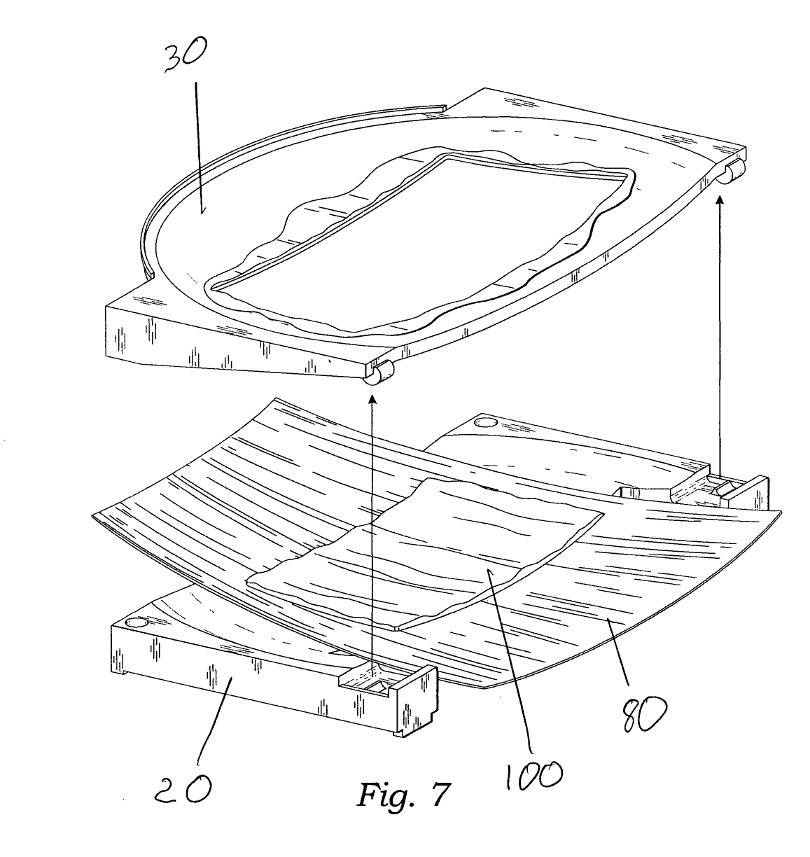

FIG. 7 is a view of the Tamale Making Device 10 showing the upper base 30 being removed and showing the masa 100 compacted and applied to the tamale wrapper 80.

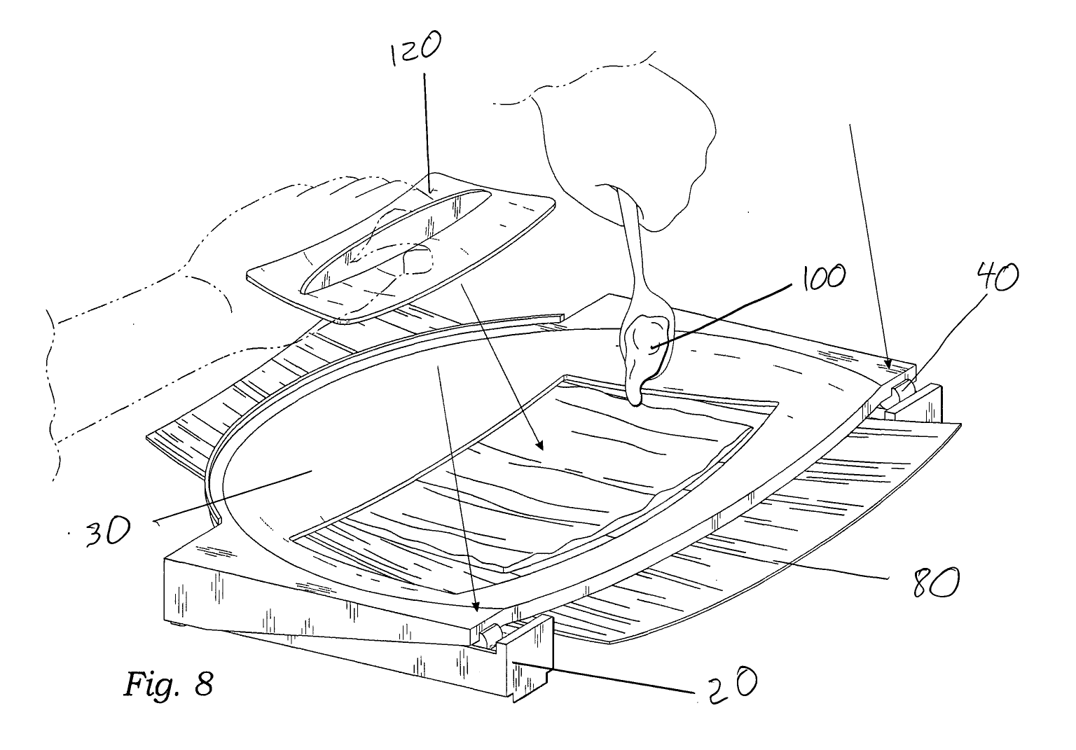

FIG. 8 is a view of the Tamale Making Device 10 showing that a second application of masa 100 can be applied to the tamale wrapper 80 positioned between the upper base 30 and the lower base 20.

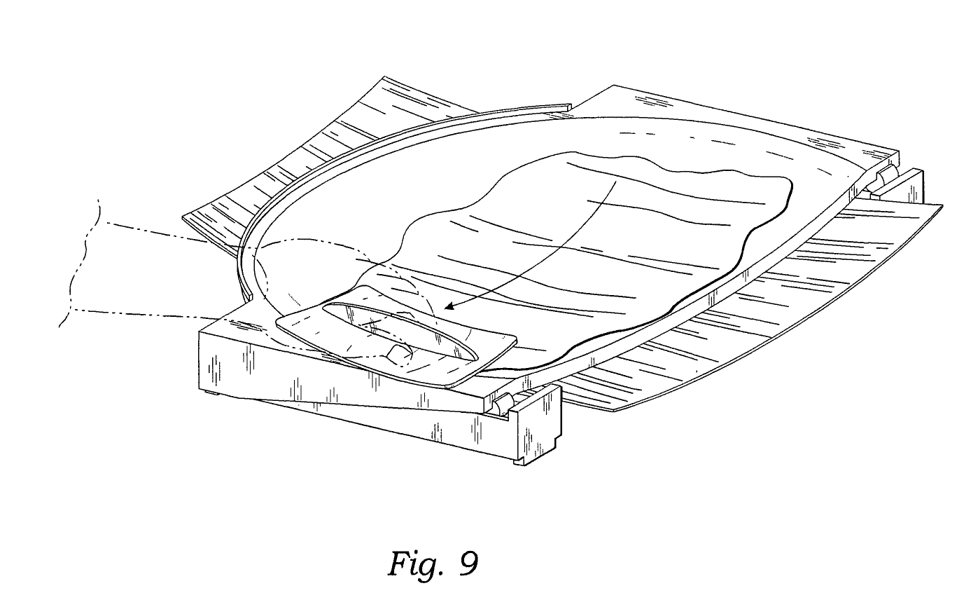

FIG. 9 is another view of the Tamale Making Device 10 showing that a second application of masa 100 is compacted and spread by the spreader 120.

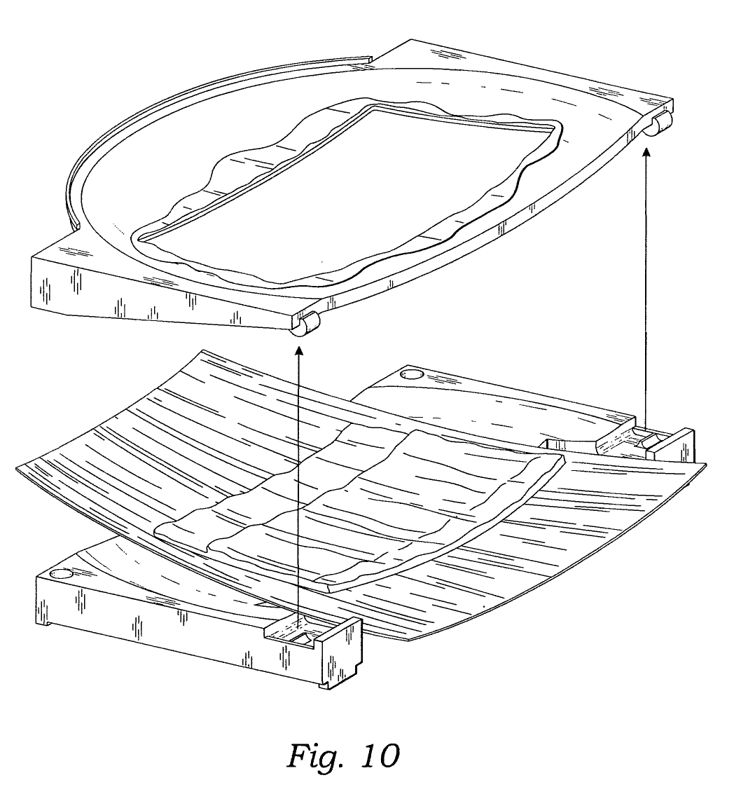

FIG. 10 is a perspective view of the Tamale Making Device 10 showing the upper base 30 being removed and showing a second application of the masa 100 compacted and applied to the tamale wrapper 80.

A Tamale making device comprising: a lower surface, an upper surface, connecting means for attaching said upper surface to said lower surface, said lower surface has means for receiving a tamale wrapper, and said upper surface has a cut out portion in the middle of said upper surface for applying a masa spread to said tamale wrapper on said lower surface.

Wherein a user desires to make tamales, said tamale wrapper is positioned such that the front of the tamale wrapper is positioned over the cut out hole in said upper surface, then said upper surface is positioned on the tamale wrapper to prevent said wrapped from moving, then said masa spread is applied to the tamale wrapper through the cut out portion, then a leveling device is used to compact the masa, then said leveling device is used to scrap away any excess masa.

Wherein after said masa spread has been applied to said tamale wrapper, then a tamale filling is placed on a portion of the masa spread, then said tamale wrapper with said masa spread is folded over said tamale filing to trap said filling between said masa spread so that the tamale is ready for cooking.

Wherein said filling can be selected from various meats, cheeses, and sliced chili peppers.

Wherein in the preferred embodiment of the invention, said upper surface is concave and said lower surface is concave.

Wherein said leveling device is comprised of a concave surface for compacting and spreading the masa.

Wherein said tamale wrapper is positioned on said lower surface such that the front of the tamale wrapper is positioned over the cut out hole in said upper surface.

Wherein said upper surface is positioned on the tamale wrapper to prevent said wrapped from moving, when said masa spread is applied to the tamale wrapper through the cut out portion.

Wherein a leveling device is used to compact and spread the masa on to said tamale wrapper then said leveling device is used to scrap away any excess masa from said upper surface.

A method of making Tamales comprising: providing a lower surface, an upper surface, connecting means for attaching said upper surface to said lower surface, said lower surface has means for receiving a tamale wrapper, said upper surface has a cut out portion in the middle of said upper surface for applying a masa spread to said tamale wrapper on said lower surface; wherein a user desires to make tamales, said tamale wrapper is positioned on said lower surface such that the front of the tamale wrapper is positioned over the cut out hole in said upper surface, then said upper surface is positioned on the tamale wrapper to prevent said wrapped from moving, when said masa spread is applied to the tamale wrapper through the cut out portion, a leveling device is used to compact and spread the masa, then said leveling device is used to scrap away any excess masa; and wherein said masa spread has been applied to said tamale wrapper, then a tamale filling is placed on a portion of the masa spread, then said tamale wrapper with said masa spread is folded over said tamale filing to trap said filling between said masa spread so that the tamale is ready for cooking.

While the description above refers to particular embodiments of the present invention, it will be understood that many modifications may be made without departing from the spirit thereof. The presently disclosed embodiments are therefore to be considered in all respects as illustrative and not restrictive.

What is claimed is:

1. A Tamale making device comprising:
a lower surface;
an upper surface;
connecting means for attaching said upper surface to said lower surface;
said lower surface has means for receiving a tamale wrapper;
said upper surface has a cut out portion in the middle of said upper surface for applying a masa spread to said tamale wrapper on said lower surface;
wherein a user desires to make tamales, said tamale wrapper is positioned such that the front of the tamale wrapper is positioned over the cut out hole in said upper surface, then said upper surface is positioned on the tamale wrapper to prevent said wrapped from moving, then said masa spread is applied to the tamale wrapper through the cut out portion, then a leveling device is used to compact the masa, then said leveling device is used to scrap away any excess masa;
wherein after said masa spread has been applied to said tamale wrapper, then a tamale filling is placed on a portion of the masa spread, then said tamale wrapper with said masa spread is folded over said tamale filing to trap said filling between said masa spread so that the tamale is ready for cooking.

2. A device as defined in claim 1, wherein said filling is meat, cheese, and sliced chili peppers.

3. A device as defined in claim 1, wherein said filling is cheese.

4. A device as defined in claim 1, wherein said filling is sliced chili peppers.

5. A device as defined in claim 1, wherein said filling is meat.

6. A device as defined in claim 1, wherein said filling is chosen from the group consisting of meats, cheese, and sliced chili peppers.

7. A device as defined in claim 1, wherein said upper surface is concave.

8. A device as defined in claim 1, wherein said lower surface is concave.

9. A device defined in claim 1, wherein said leveling device is comprised of a concave surface for compacting and spreading the masa.

10. A Tamale making device comprising:
a lower surface;
an upper surface;
said lower surface has a slot for attaching said upper surface to said lower surface;
said lower surface has means for receiving a tamale wrapper; and
said upper surface has a cut out portion in the middle of said upper surface for applying a masa spread to said tamale wrapper on said lower surface.

11. A device as defined in claim 10, wherein said upper surface is concave.

12. A device as defined in claim 10, wherein said lower surface is concave.

13. A device as defined in claim 10, wherein said tamale wrapper is positioned on said lower surface such that the front of the tamale wrapper is positioned over the cut out hole in said upper surface.

14. A device as defined in claim 10, wherein said upper surface is positioned on the tamale wrapper to prevent said wrapped from moving, when said masa spread is applied to the tamale wrapper through the cut out portion.

15. A device as defined in claim 10, wherein a leveling device is used to compact and spread the masa on to said tamale wrapper then said leveling device is used to scrap away any excess masa from said upper surface.

16. A method of making Tamales comprising:
providing a lower surface, an upper surface, connecting means for attaching said upper surface to said lower surface, said lower surface has means for receiving a tamale wrapper, said upper surface has a cut out portion in the middle of said upper surface for applying a masa spread to said tamale wrapper on said lower surface;
wherein a user desires to make tamales, said tamale wrapper is positioned on said lower surface such that the front of the tamale wrapper is positioned over the cut out hole in said upper surface, then said upper surface is positioned on the tamale wrapper to prevent said wrapped from moving, when said masa spread is applied to the tamale wrapper through the cut out portion, a leveling device is used to compact and spread the masa, then said leveling device is used to scrap away any excess masa; and
wherein said masa spread has been applied to said tamale wrapper, then a tamale filling is placed on a portion of the masa spread, then said tamale wrapper with said masa spread is folded over said tamale filing to trap said filling between said masa spread so that the tamale is ready for cooking.

17. A device as defined in claim 1, wherein said filling is chosen from the group consisting of meats, cheeses, and sliced chili peppers.

18. A device as defined in claim 1, wherein said upper surface is concave.

19. A device as defined in claim 1, wherein said lower surface is concave.

20. A device defined in claim 1, wherein said leveling device is comprised of a concave surface for compacting and spreading the masa.
